(19) United States
(12) Patent Application Publication
(10) Pub. No.: US 2023/0316046 A1
(43) Pub. Date: Oct. 5, 2023

(54) EVALUATION AND TRAINING OF MACHINE LEARNING MODULES WITHOUT CORRESPONDING GROUND TRUTH DATA SETS

(71) Applicant: Bodygram, Inc., New York, NY (US)

(72) Inventors: Ito Takafumi, Saitama (JP); Kyohei Kamiyama, Tokyo (JP)

(21) Appl. No.: 18/025,648

(22) PCT Filed: Sep. 17, 2021
(86) PCT No.: PCT/US2021/050798

§ 371 Date: Mar. 10, 2023

Related U.S. Application Data
(60) Provisional application No. 62/706,905, filed on Sep. 17, 2020.

(51) Int. Cl. G06N 3/045

(52) U.S. Cl. CPC G06N 3/045

(57) ABSTRACT

Methods and systems are disclosed for evaluating or training a machine learning module when its corresponding truth data sets are unavailable or unreliable. The methods and systems are configured for evaluating or training a target machine learning module having a first (system) input and a first output, wherein the target module is connected to a second machine learning module having an intermediate input (identical to the first output of the target module) and a second (system) output, by training the second module using received corresponding intermediate and output data sets, generating an evaluation data set using a received system input data set, and evaluating or training the target module using a loss function based on a distance metric between the evaluation data set and a received system output data set corresponding to the system input data set.

### FIELD OF THE INVENTION

Embodiments of the present invention are in the field of evaluating and training a machine learning (ML) module when its corresponding truth data sets are unavailable, using a second trainable ML module. Embodiments are applicable to automated body measurements.

### BACKGROUND OF THE INVENTION

The statements in the background of the invention are provided to assist with understanding the invention and its applications and uses, and may not constitute prior art.

There are multiple applications in which machine learning (ML) modules need to be trained, where corresponding ground truth data sets are not necessarily available, complete, or reliable.

In automated body measurements, obtaining an accurate estimate of the measurements of a user has many useful applications. For example, clothing, accessory, and footwear retail require estimation of body measurements. Besides, fitness tracking and weight loss tracking require estimation of body weight. Accurately estimating clothing size and fit can be based on body part length and body weight measurements. Such an estimation can be performed with machine learning through a multi-stage process having user images as an input and one or more body or body-part measurements as an output. The annotation of user images is often required as an initial stage in this process, where annotation is the generation of annotation keypoints or annotation lines indicating corresponding body feature measurement locations underneath user clothing for one or more identified body features (e.g., height, size of foot, size of arm, size of torso, etc.). Image annotations may be carried out through one or more annotation ML modules that have been trained on each body feature, such as an annotation deep neural network (DNN).

The second stage of the process uses the keypoint or line annotations as an intermediate input to generate one or more body or body part measurements. This stage is carried out through one or more ML modules that have been trained to generate one or more measurements from keypoint or line annotations of one or more body features, such as a regressor. Other machine learning methods are also within the scope of the annotation and measurement ML modules. For example, other ML algorithms including, but are not limited to, nearest neighbor, decision trees, support vector machines (SVM), Adaboost, Bayesian networks, fuzzy logic models, various neural networks including deep learning networks, evolutionary algorithms, and so forth, are within the scope of the present invention. In the context of the present disclosure, the above ML methods represent different ML types.

Prior to deployment, pre-trained ML models for the two ML modules may need to be evaluated and compared, whereas untrained models may need to also be trained, verified, and tested. Evaluating and training the ML modules usually requires at least three corresponding ground truth data sets representing the input (e.g., user images), the output (e.g., measurements), and the intermediate input (e.g., keypoints); where the “ground truth” qualifier is used for output data sets, but also for corresponding input-output data sets comprising an input data set and a corresponding ground truth output data set.

Importantly, while corresponding input-output data sets (i.e., user images and measurements) are readily available through scanners, and while corresponding intermediate-output data sets (i.e., keypoints and measurements) are easily generated artificially, obtaining corresponding input and intermediate data sets is difficult.

Annotation ML modules are usually evaluated and trained using manually determined keypoints, where body segmentation, i.e., estimating a sample human's body underneath the clothing, and body annotation, i.e., drawing keypoints or lines for each body feature for the sample human, are both carried out manually by a human annotator. The annotation ML modules are then trained on the manually annotated images collected and annotated for thousands of sample humans.

Such evaluation and training data for the annotation ML is difficult to obtain. Furthermore, even when available, it is difficult to assess for quality and accuracy.

Therefore, it would be an advancement in the state of the art to provide a system and method for estimating the performance of a pre-trained annotation ML module or for training an untrained annotation ML module without access to the intermediate ground truth data set, using only corresponding intermediate-output and input-output data sets. A related method can also be used to evaluate different human annotators or different human or non-human annotation schemes.

There are other applications in which machine learning modules need to be trained where corresponding ground truth data sets are not necessarily available, complete, or reliable.

It is against this background that the present invention was developed.

### BRIEF SUMMARY OF THE INVENTION

The present invention relates to methods and systems for evaluating or training a machine learning (ML) module for image annotation when its corresponding truth data sets are unavailable or unreliable. Related computer-implemented methods can be used to evaluate human annotators and annotation schemes.

More specifically, in various embodiments, the present invention is a computer-implemented method for evaluating a first machine learning module (M_{AB}) having a first input and a first output, wherein the first machine learning module (M_{AB}) is connected to a second machine learning module (M_{BC}) having a second input and a second output, and wherein the first output of the first machine learning module (M_{AB}) is the second input of the second machine learning module (M_{BC}), the computer-implemented method executable by a hardware processor, the method comprising: receiving an intermediate data set (B₁) and a corresponding output data set (C₁), wherein the intermediate data set (B₁) represents a data set for the second input of the second machine learning module (M_{BC}), and wherein the output data set (C₁) represents a corresponding ground truth data set for the second output of the second machine learning module (M_{BC}); training the second machine learning module (M_{BC}) using the intermediate data set (B₁) and the output data set (C₁); receiving a system input data set (A₂) and a corresponding system output data set (C₂), wherein the system input data set (A₂) represents a data set for the first input of the first machine learning module, and wherein the system output data set (C₂) represents a corresponding ground truth data set for the second output of the second machine learning module (M_{BC}); generating a first evaluation data set (C′), wherein each data point in the first evaluation data set (C′) is generated by the second machine learning module (M_{BC}) when a corresponding data point of the system input data set (A₂) is input to the first machine learning module; and evaluating the first machine learning module (M_{AB}) using a loss function based on a first distance metric between the first evaluation data set (C′) and the system output data set (C₂).

In another embodiment, the method further comprises substituting the first machine learning module (M_{AB}) with a third machine learning module (N_{AB}) having a third input and a third output, such that the third output of the third machine learning module (N_{AB}) is the second input of the second machine learning module (M_{BC}); generating a second evaluation data set (C″), wherein each data point in the second evaluation data set (C″) is generated by the second machine learning module (M_{BC}) when a corresponding data point of system input data set (A₂) is input to the third machine learning module (N_{AB}); evaluating the third machine learning module (N_{AB}) using the loss function based on a second distance metric between the second evaluation data set (C″) and the system output data set (C₂); and selecting one of the first machine learning module (M_{AB}) and the third machine learning module (N_{AB}) based on the loss function.

In one embodiment, the method further comprises tuning the parameters of the first machine learning module (M_{AB}) based on the loss function.

In one embodiment, the first machine learning module (M_{AB}) is a different type of machine learning module than the second machine learning module (M_{BC}).

In one embodiment, the first machine learning module (M_{AB}) has a different type of output than the second machine learning module (M_{BC}).

In one embodiment, the method further comprises training the first machine learning module (M_{AB}) using the loss function, the system input data set (A₂), and the system output data set (C₂), wherein the trained second machine learning module (M_{BC}) is fixed.

In various embodiments, the system input data set (A₂) comprises photos of clothed individuals, the intermediate data set (B₁) comprises keypoint annotations of one or more body parts under clothing, and the output data sets (output data set (C₁) and system output data set (C₂)) comprise measurements of the one or more body parts.

In one embodiment, the first machine learning module (M_{AB}) is selected from the group consisting of a deep neural network (DNN) and a regressor.

In one embodiment, the first machine learning module (M_{AB}) is a residual neural network (ResNet).

In another embodiment, the second machine learning module (M_{BC}) is selected from the group consisting of a deep neural network (DNN) and a regressor.

In yet another embodiment, the first distance metric is a batch distance measure selected from the group consisting of a mean absolute error (MAE), a mean squared error (MSE), a mean squared deviation (MSD), and a mean squared prediction error (MSPE).

In one embodiment, the method further comprises receiving an intermediate output data set (B₂) corresponding to the system input data set (A₂), wherein the intermediate output data set (B₂) represents a ground truth data set for the first output of the first machine learning module (M_{AB}); and generating an intermediate evaluation data set (B′), wherein each data point in the intermediate evaluation data set (B′) is generated by the first machine learning module (M_{AB}) when a corresponding data point of the system input data set (A₂) is input to the first machine learning module, wherein the loss function is based on the first distance metric between the first evaluation data set (C′) and the system output data set (C₂) and a third distance metric between the intermediate evaluation data set (B′) and the intermediate output data set (B₂).

In other embodiments, the present invention is a computer-implemented method for evaluating a first annotator (T_{AB}) generating keypoint annotations of one or more body parts under clothing from one or more photos of clothed individuals, wherein the keypoint annotations are input to a machine learning module (M_{BC}) used to generate one or more body part measurements, the computer-implemented method executable by a hardware processor, the method comprising: receiving a keypoint data set (B₁) and a corresponding measurement data set (C₁), wherein the keypoint data set (B₁) represents a data set input for the machine learning module (M_{BC}), and the measurement data set (C₁) represents a corresponding ground truth output data set for the machine learning module (M_{BC}); training the machine learning module (M_{BC}) using the keypoint data set (B₁) and the measurement data set (C₁); receiving a photo data set (A₂) and a corresponding measurement data set (C₂), wherein the photo data set (A₂) comprises photos of clothed individuals, and the measurement data set (C₂) comprises measurements of one or more body parts of the clothed individuals; generating a first evaluation data set (C′), wherein each data point in the first evaluation data set (C′) is a body part measurement generated by the machine learning module (M_{BC}) when a corresponding photo of the photo data set (A₂) is annotated by the first annotator (T_{AB}); and evaluating the first annotator (T_{AB}) using a loss function based on a distance metric between the first evaluation data set (C′) and the measurement data set (C₂).

In one embodiment, the method further comprises substituting the first annotator (T_{AB}) with a second annotator (K_{AB}), wherein the keypoint annotations generated by the K_{AB} are input to the machine learning module (M_{BC}) to generate one or more body part measurements; generating a second evaluation data set (C″), wherein: each data point in the second evaluation data set (C″) is a body part measurement generated by the machine learning module (M_{BC}) when a corresponding photo of the photo data set (A₂) is annotated by the second annotator (K_{AB}); evaluating the performance of the second annotator (K_{AB}) using the loss function based on the distance metric between the second evaluation data set (C″) and the measurement data set (C₂); and selecting one of the first annotator (T_{AB}) and the second annotator (K_{AB}) based on the loss function.

In various embodiments, a computer program product is disclosed. The computer program may be used for evaluating or training a machine learning (ML) module for image annotation when its corresponding truth data sets are unavailable, or for evaluating human annotators and other non-human (e.g., computer-based) annotation schemes, and may include a computer readable storage medium having program instructions, or program code, embodied therewith, the program instructions executable by a processor to cause the processor to perform the steps recited herein.

In various embodiment, a system is described, including a memory that stores computer-executable components; a hardware processor, operably coupled to the memory, and that executes the computer-executable components stored in the memory, wherein the computer-executable components may include components communicatively coupled with the processor that execute the aforementioned steps.

In another embodiment, the present invention is a non-transitory, computer-readable storage medium storing executable instructions, which when executed by a processor, causes the processor to perform a process for evaluating or training a machine learning (ML) module for image annotation when its corresponding truth data sets are unavailable, or for evaluating human annotators and annotation schemes, the instructions causing the processor to perform the aforementioned steps.

In another embodiment, the present invention is a system for evaluating or training a machine learning (ML) module for image annotation when its corresponding truth data sets are unavailable, or for evaluating human annotators and annotation schemes, the system comprising a user device having a 2D camera, a processor, a display, a first memory; a server comprising a second memory and a data repository; a telecommunications-link between said user device and said server; and a plurality of computer codes embodied on said first and second memory of said user-device and said server, said plurality of computer codes which when executed causes said server and said user-device to execute a process comprising the aforementioned steps.

In yet another embodiment, the present invention is a computerized server comprising at least one processor, memory, and a plurality of computer codes embodied on said memory, said plurality of computer codes which when executed causes said processor to execute a process comprising the aforementioned steps.

Other aspects and embodiments of the present invention include the methods, processes, and algorithms comprising the steps described herein, and also include the processes and modes of operation of the systems and servers described herein.

Yet other aspects and embodiments of the present invention will become apparent from the detailed description of the invention when read in conjunction with the attached drawings.

### BRIEF DESCRIPTION OF THE DRAWINGS

Embodiments of the present invention described herein are exemplary, and not restrictive. Embodiments will now be described, by way of examples, with reference to the accompanying drawings, in which:

FIG. 1 is an illustrative diagram of the problem statement, showing the missing corresponding data sets required to evaluate or train a ML module in a multi-stage ML setup, in accordance with an embodiment of the invention.

FIG. 2 is another illustrative diagram of the problem statement, set in the context of body part measurement, and showing the missing corresponding data sets required to evaluate or train an annotation ML module, in accordance with another embodiment of the invention.

FIG. 3 is yet another illustrative diagram of a related problem statement, also set in the context of body part measurement, and showing the difficulty to assess the corresponding data sets required to evaluate a human annotator or an annotation scheme, in accordance with another embodiment of the invention.

FIG. 4 shows an exemplary system diagram for training a keypoint annotation deep neural network (DNN) module used in the context of body part measurement, when the corresponding truth data sets for training of the DNN are unavailable or unreliable, in accordance with one embodiment of the invention.

FIG. 5 shows an exemplary system diagram for evaluating and selecting one or more trained keypoint annotation deep neural network (DNN) modules used in the context of body part measurement, when the corresponding truth data sets for evaluation of the DNNs are unavailable or unreliable, in accordance with one embodiment of the invention.

FIG. 6 shows a diagram for evaluating or training a machine learning (ML) module when its corresponding truth data sets are unavailable or unreliable, in accordance with another embodiment of the invention.

FIG. 7 shows an illustrative scenario for evaluating or training one or more machine learning (ML) modules when their corresponding truth data sets are unavailable or unreliable, in accordance with yet another embodiment of the invention.

FIG. 8 shows an example flow diagram for a ML evaluation process without corresponding truth data sets, in accordance with another embodiment of the invention.

FIG. 9 shows an example flow diagram for a ML selection process without corresponding truth data sets, in accordance with another embodiment of the invention.

FIG. 10 shows an example flow diagram for a ML training process without corresponding truth data sets, in accordance with another embodiment of the invention.

FIG. 11 shows an example flow diagram for evaluating an annotator without input-output data sets, in accordance with another embodiment of the invention.

FIG. 12 shows an example flow diagram for selecting an annotator without input-output data sets, in accordance with another embodiment of the invention.

FIG. 13 shows an illustrative diagram for a ML algorithm (used for generating keypoint annotations) for which parameters can be modified or tuned without corresponding ground truth data sets, in accordance with yet another embodiment of the invention.

FIG. 14 provides a schematic of a server (management computing entity) according to one embodiment of the present invention.

FIG. 15 provides an illustrative schematic representative of a client (user computing entity) that can be used in conjunction with embodiments of the present invention.

FIG. 16 shows an illustrative system architecture diagram for implementing one embodiment of the present invention in a client-server environment.

### DETAILED DESCRIPTION OF THE INVENTION

### Overview

This application is related to U.S. Ser. No. 16/195,802, filed on 19 Nov. 2018, which issued as U.S. Pat. No. 10,321,728, issued on 18 Jun. 2019, entitled “SYSTEMS AND METHODS FOR FULL BODY MEASUREMENTS EXTRACTION,” which itself claims priority from U.S. Ser. No. 62/660,377, filed on 20 Apr. 2018, and entitled “SYSTEMS AND METHODS FOR FULL BODY MEASUREMENTS EXTRACTION USING A 2D PHONE CAMERA,” the entire disclosures of both of which are hereby incorporated by reference in their entireties herein.

With reference to the figures provided, embodiments of the present invention are now described in detail.

In the following description, for purposes of explanation, numerous specific details are set forth in order to provide a thorough understanding of the invention. It will be apparent, however, to one skilled in the art that the invention can be practiced without these specific details. In other instances, structures, devices, activities, and methods are shown using schematics, use cases, and/or flow diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

In the present disclosure, the term “2D phone camera” is used to represent any traditional camera embedded in, or connected to, computing devices, such as smart phones, tablets, laptops, desktops, and the like. The terms “user images” and “photos” represent photos taken using such devices.

### Problem Statement

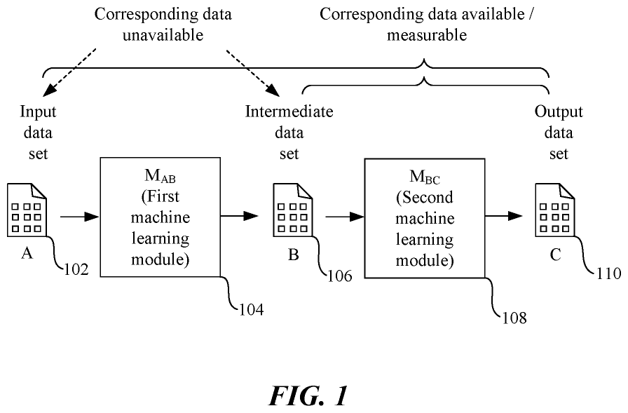

FIG. 1 is an illustrative diagram of the problem statement, showing the missing corresponding data sets required to evaluate or train a ML module in a multi-stage ML setup, in accordance with an embodiment of the invention. FIG. 1 shows a two-stage ML process where a first machine learning module 104 (M_{AB}) having one input A and one output B, connected to a second machine learning module (M_{BC}) 108 having one input B and one output C, such that the output of M_{AB} is the input of the M_{BC}. Therefore, B represents both the output of M_{AB} and the input of M_{BC}. FIG. 1 shows the three data sets required for the training of M_{AB} and M_{BC}, namely an input data set 102 comprising A data points, an intermediate data set 106 comprising B data points, and an output data set 110 comprising C data points.

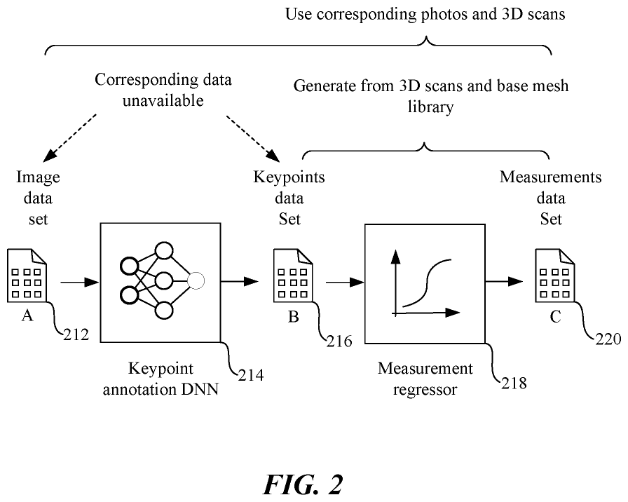

The evaluation or training of a ML module, such as M_{AB} and M_{BC}, requires corresponding input-output data points. Specifically, evaluating or training an M_{BC} ML model requires (B, C) ground truth data sets (i.e., 106 and 110), whereby each data point in the B data set has one corresponding data point in the C data set. Similarly, evaluating or training a M_{AB} ML model requires (A, B) ground truth data sets (i.e., 102 and 106), whereby each data point in the A data set has one corresponding data point in the B data set. Such evaluation and training data sets are usually collected from specifically designed measurement or data collection campaigns, as is discussed in the example setup of FIG. 2.

The particularly of this setup is that while corresponding input-output data sets for evaluating or training M_{BC} are available, corresponding input-output data sets for evaluating or training M_{AB} are unavailable or unreliable. Rather, corresponding global, or system, input-output data, represented in this case by data sets 102 for A and 110 for C, is available.

The unavailability (or unreliability) of corresponding input-output ground truth data sets for training a ML model (e.g., 104) may stem from a number of practical factors such as the high difficulty, cost, duration, or complexity of existing data collection mechanisms. Similarly, the availability of global input-output ground truth data (also referred to herein as system input-output ground truth data, e.g., 102, 110) may be facilitated by the relative ease, low cost, speed, or simplicity of the corresponding data collection mechanisms. These factors are further illustrated in the context of the example of FIG. 2.

FIG. 2 is another illustrative diagram of the problem statement, set in the context of body part measurement, and showing the missing corresponding data sets required to evaluate or train an annotation ML module, in accordance with another embodiment of the invention.

Accurately estimating various body-related physical quantities such as body measurements (e.g., height), body part measurements (e.g., arm or foot dimensions), body weight, etc., can be performed through a multi-stage process having user images as an input and one or more body or body part measurements as an output. The annotation of user images is often required as an initial stage in this process, where annotation is the generation of annotation keypoints or annotation lines indicating corresponding body feature measurement locations underneath user clothing for one or more identified body features (e.g., height, size of foot, size of arm, size of torso, etc.). Image annotations may be carried out through one or more annotation ML modules that have been trained on each body feature, such as an annotation deep neural network (DNN). In the application of FIG. 2, the first ML module 214 is a keypoint annotation DNN. Once trained, a keypoint annotation DNN 214 generates keypoints of body parts under clothing (B) from clothed user images (A).

The second stage of the process is a measurement stage where the keypoint annotations (B) are used as an intermediate input to generate one or more body or body part measurements (C). This stage is carried out through one or more ML modules 218 that have been trained to generate one or more measurements of one or more body features (C) from the keypoint annotations (B). In FIG. 2, a regressor ML module 218 is used for the measurement stage.

Prior to deployment, pre-trained ML models for the two ML modules (214, 218) may need to be evaluated and compared. Furthermore, untrained models of the two ML modules (214, 218) may need to also be trained, verified, and tested. Evaluating and training the ML modules usually requires at least three corresponding ground truth data sets representing the input user images 212 (A), the output measurements 220 (C), and the intermediate input keypoints 216 (B).

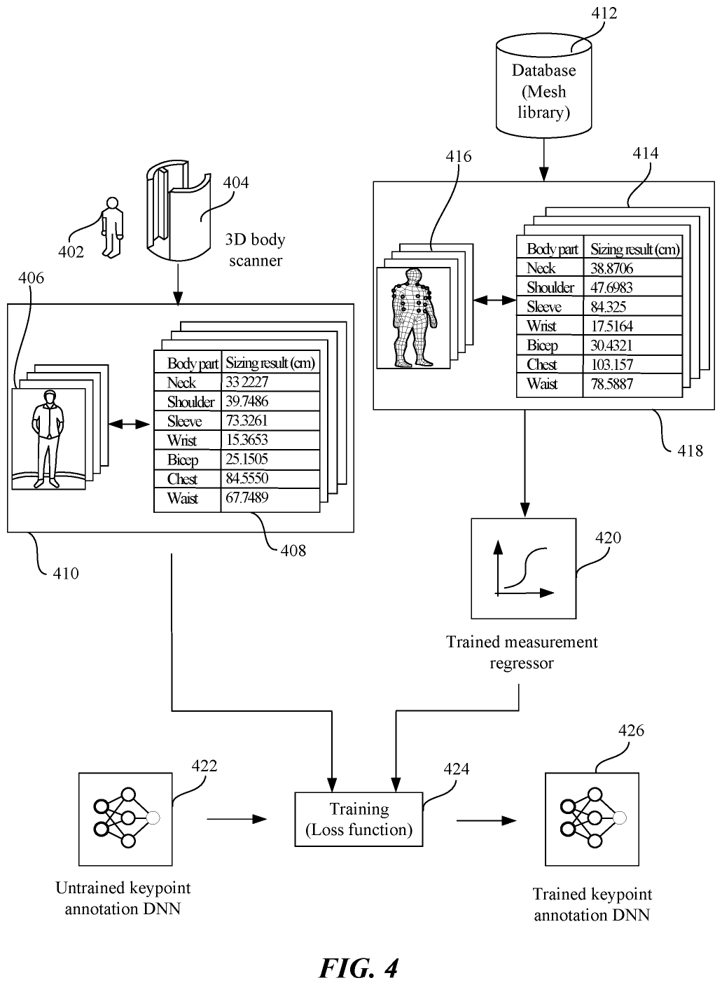

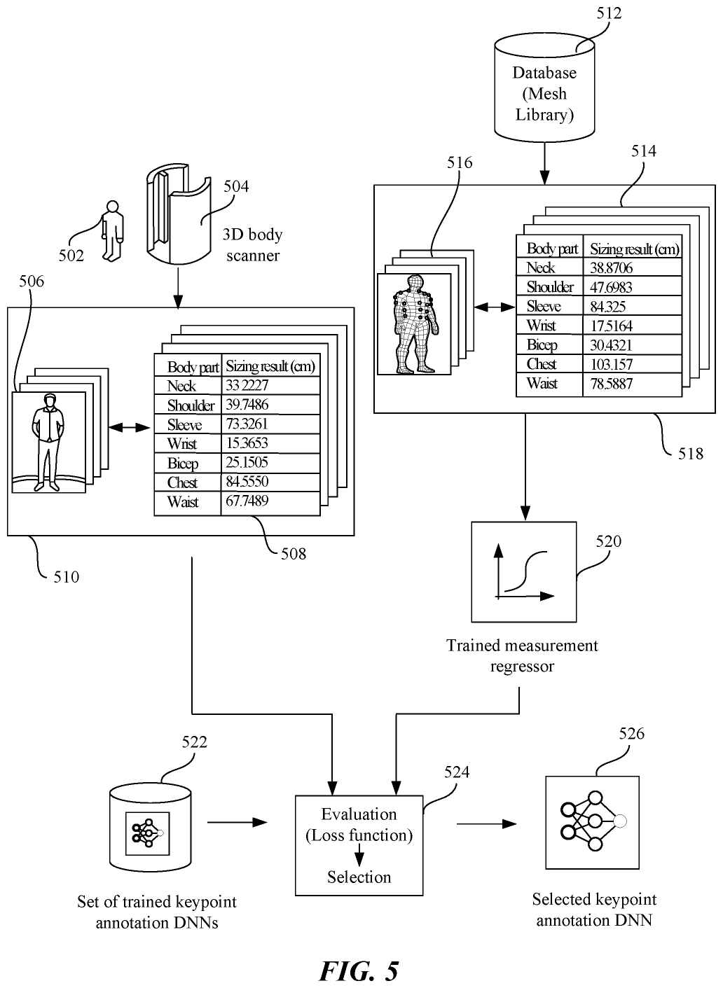

In this application, corresponding input-output (A, C) data sets (i.e., user images 212 and measurements 220) are readily available through 3D scanners, where the same individuals are photographed with clothing, yielding an image data set 212, and scanned (see FIGS. 4 and 5). Ground-truth target body feature measurements 220 are then determined from their 3D nude scans. Similarly, corresponding intermediate-output (B, C) data sets (i.e., keypoints 216 and measurements 220) are also easily generated artificially. Specifically, 3D nude scans of clothed body parts are compared to a library of annotated 3D base meshes of the same body parts in order to derive ground-truth keypoints 216. Besides, ground-truth body part measurements 220 are determined from the same 3D nude scans, hence yielding a corresponding input-output data set for training the measurement regressor 218.

Obtaining corresponding input 212 and intermediate 216 data sets, however, is difficult. Annotation ML modules are usually evaluated and trained using manually determined keypoints, where body segmentation, i.e., estimating a sample human's body underneath the clothing, and body annotation, i.e., drawing keypoints or lines for each body feature for the sample human, are both carried out manually by a human annotator. The annotation ML modules are then trained on the manually annotated images collected and annotated for thousands of sample humans.

Such ground truth evaluation and training data for the annotation ML 214 is time-consuming, costly, and hard to obtain as it requires the manual labor of multiple annotators. Furthermore, annotation accuracy and clarity need to be assessed ahead of any use of the generated corresponding (A, B) data sets for the evaluation or training of annotation ML modules 214. The variation in accuracy and quality emanates from the differences in manual annotator performance, but also from the performance variations among multiple annotation mechanisms used by the annotators (e.g., computer-aided manual annotation, scanned physical image annotation, etc.).

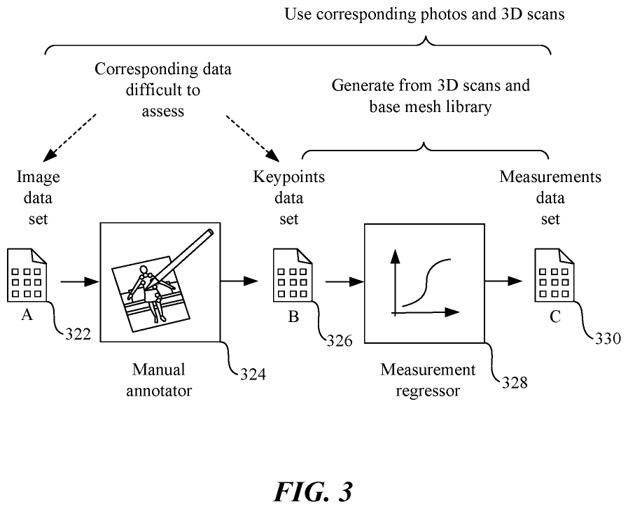

FIG. 3 shows a setup for generating body or body part measurements, where the annotation stage uses a manual annotator 324 rather than a first annotation ML module (e.g., a DNN) 214. As in the setup of FIG. 2, a regressor 328 is used to carry out the measurement stage. FIG. 3 illustrates the problem with evaluating manual annotators described above, where the image 322 (A) and keypoint 326 (B) data sets produced by an annotator are difficult to assess for keypoint clarity and accuracy, even though corresponding ground-truth keypoint 326 to measurement 330 (i.e., B to C) and image 322 to measurement 330 (i.e., A to C) data sets are readily available.

The current invention hence addresses the evaluation and training of a first ML module (104, 214) without corresponding ground truth input (102, 212) and intermediate (106, 216) data sets by using existing a second ML module (108, 218), its corresponding intermediate (106, 216) and output (110, 220) data sets, and corresponding global (or system) input (102, 212) and output (110, 220) data sets. Related methods are also disclosed to evaluate a process or transformation such as annotation (324). The “unavailability” of input (102, 212) and intermediate (106, 216) data sets in FIGS. 1 and 2 also indicate the unavailability of quality and performance assessment mechanisms for the existing data-collection mechanisms, rendering collected data sets unreliable or partially reliable.

It is important to note that the disclosed methods to evaluate one or more human annotators 324 can be used to also evaluate one or more annotation mechanisms. The term “annotator” henceforth generally includes human and non-human (e.g., computer-based) annotation schemes.

### Evaluation, Selection, and Training of a Keypoint Annotation DNN

FIG. 4 shows an exemplary system diagram for training a keypoint annotation deep neural network (DNN) module used in the context of body part measurement, when the corresponding truth data sets for training of the DNN are unavailable or unreliable, in accordance with one embodiment of the invention.

In a first step shown on the right side of the figure, a measurement regressor module designed to generate measurements for one or more body parts underneath clothing is trained 420 using input-output truth data sets 418 obtained from a database such as a mesh library 412. In the example embodiment of FIG. 4, the body part is the human torso, the input is a set of body part (e.g., torso) keypoints 416, and the output is a set of corresponding ground truth measurements 414.

In a second step shown on the left side of the figure, the ground truth system input and output data sets 410 are received from 3D body scans of one or more users 402 using a 3D body scanner 404. In FIG. 4, the system input is a set of body part (e.g., torso) photos 406 of the one or more users 402, representing the input for a keypoint annotation DNN 422 (i.e., the training target ML module), and the system output 408 represents corresponding ground truth body-part (e.g., torso) measurement outputs. The input images 406 and output body part measurements 408 are hence global (or system) ground-truth input-output data sets spanning the concatenated DNN and regressor (see FIG. 2). A ground-truth keypoint set corresponding to the input body part images 406 (i.e., an intermediate data set) is either unavailable, difficult to obtain, or difficult to assess for quality (i.e., partially or fully unreliable).

In a third step (not shown in FIG. 4), an evaluation data set is generated by passing a plurality data points from the input image data set 406 through the concatenated DNN and regressor modules to obtain an evaluation measurement data set, as depicted in FIG. 2.

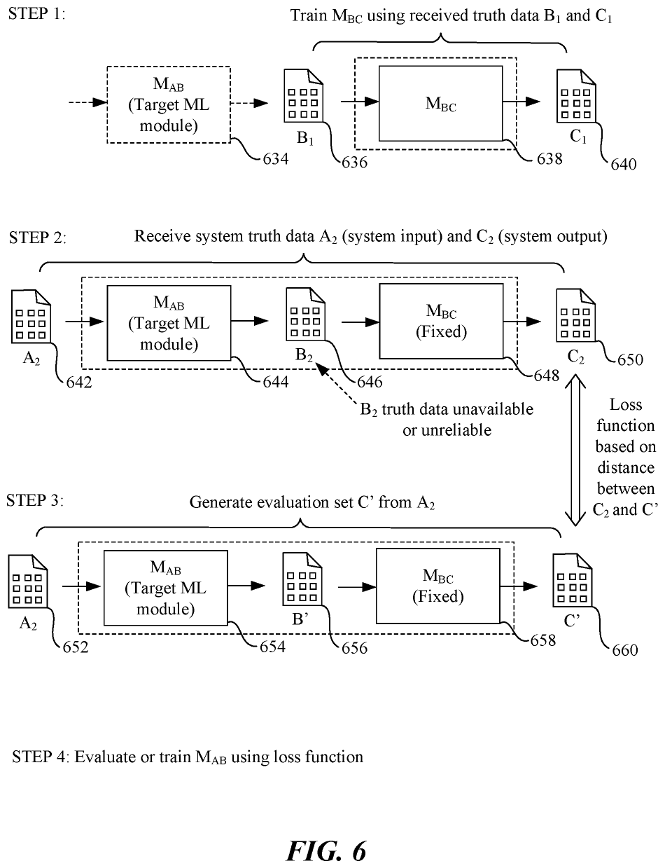

Finally, in a fourth step shown at the bottom of the figure, the training 424 of the keypoint annotation DNN 422 is carried out using a loss function based on a distance metric between the generated evaluation measurement data set and the system ground truth data set 408, leading to a trained keypoint annotation DNN 426. The training method is further discussed in the context of FIG. 6.

FIG. 5 shows an exemplary system diagram for evaluating and selecting one or more trained keypoint annotation deep neural network (DNN) modules used in the context of body part measurement, when the corresponding truth data sets for evaluation of the DNNs are unavailable or unreliable, in accordance with one embodiment of the invention.

In a first step shown on the right side of the figure, a measurement regressor module designed to generate measurements for one or more body parts underneath clothing is trained 520 using input-output truth data sets 518 obtained from a database such as a mesh library 512. As in FIG. 4, the body part is the human torso, the input is a set of body part (e.g., torso) keypoints 516, and the output is a set of corresponding ground truth measurements 514.

In a second step shown on the left side of the figure, the ground truth system input and output data sets 510 are received from 3D body scans of one or more users 502 using a 3D body scanner 504. As in FIG. 4, the system input is a set of body part (e.g., torso) photos 506 of the one or more users 502, representing the input for a keypoint annotation DNN 522 (i.e., the evaluation and/or selection target ML module), and the system output 508 represents corresponding ground truth body-part (e.g., torso) measurement outputs. The input images 506 and output body part measurements 508 are hence global (or system) ground-truth input-output data sets spanning the concatenated DNN and regressor (see FIG. 2). A ground-truth keypoint set corresponding to the input body part images 506 (i.e., an intermediate data set) is either unavailable, difficult to obtain, or difficult to assess for quality (i.e., partially or fully unreliable).

In a third step (not shown in FIG. 4), an evaluation data set is generated by passing a plurality data points from the input image data set 506 through the concatenated DNN and regressor modules to obtain an evaluation measurement data set, as depicted in FIG. 2.

Finally, in a fourth step shown at the bottom of the figure, the evaluation 524 of a set of trained keypoint annotation DNNs 522 is carried out using a loss function based on a distance metric between the generated evaluation measurement data set and the system ground truth data set 508, leading to the evaluation and selection 524 of one or more trained keypoint annotation DNN 526, where the selection is based on the evaluation. The evaluation method is further discussed in the context of FIG. 6.

### ML Module Evaluation and Training

FIG. 6 shows a diagram for evaluating or training the target machine learning (ML) module of FIG. 1, in accordance with an embodiment of the invention.

In a first step (STEP 1), the second ML module M_{BC} 638 is trained using its received (available) input-output truth data sets B₁ 636 and C₁ 640. In this step, the first (target) ML module 634 is not used.

In a second step (STEP 2), the ground truth input 642 (A₂) and output 650 (C₂) data sets are received, where A₂ 642 represents input for the evaluation or training target ML module M_{AB} 644, and the C₂ 650 represents corresponding ground truth output for the second ML module M_{BC} 648. A₂ and C₂ are hence global (or system) ground-truth input-output data sets spanning the concatenated ML modules (shown in a dashed box). A corresponding intermediate data set (B₂) 646 is either unavailable, difficult to obtain, or difficult to assess for quality.

In a third step (STEP 3), an evaluation data set (C′) 660 is generated by passing one or more data points from the input data set A₂ 652 through the concatenated ML modules (shown in a dashed box). Hence, each data point in C′ is the output of the second ML module M_{BC} 658 when a corresponding data point of A₂ is input to the target ML module M_{AB} 654. B′ 656 represents a corresponding intermediate evaluation data set (B′), where each data point in B′ is the output of the first ML module M_{AB} 654 when a corresponding data point of A₂ is input to M_{AB}.

Finally, in a fourth step (STEP 4), an evaluation of the target ML module M_{AB} 654 is carried out using a loss function based on a distance metric between the evaluation data set (C′) 660 and the output data set (C₂) 650. Such an evaluation can be based on corresponding portions of the input, output, and evaluation sets (A₂, C₂, and C′) rather than on their entirety. For example, in a ML training process, the corresponding ground truth data sets are usually divided into corresponding batches and used successively and repeatedly to modify the parameters of a ML model. In such a training context, the evaluation of the target ML module M_{AB} can be regarded as a first step to its training, validation, and testing (see discussion and example below).

The intermediate evaluation data set (B′) may be unavailable (e.g., difficult to measure), unreliable, or partially reliable. In some embodiments of the invention, ground truth for the intermediate output (e.g., “B₂”) may be available and may be used, together with the intermediate evaluation data set (B′), for the evaluation step, alongside C′ and C₂, as discussed below in more detail.

The methods described herein can be applied where more than one ML module is attached to the target ML module to be evaluated or trained. In reference to FIG. 6, this generalized scenario would imply the concatenation of X in-series ML modules on the input side of a target ML module (e.g., M_{AB}) and the concatenation of Y in-series ML modules on the output side of the target ML module, where X+Y>0, and X and Y are both natural numbers.

The above generalized scenario requires two conditions to be satisfied. First, corresponding ground truth input-output data sets must be available to train each of the ML modules other than the target ML module (e.g., (B₁, C₁) in FIG. 6). Second, a system input-output data set must also be available (e.g., (A₂, C₂) in FIG. 6). More generally, in addition to the available (X+Y) ground truth input-output data sets of the non-target individual ML modules, it would be sufficient to have one input-output ground truth data set for any concatenated system of ML modules comprising the target ML module. The method would then be used to iteratively evaluate and train the target ML module.

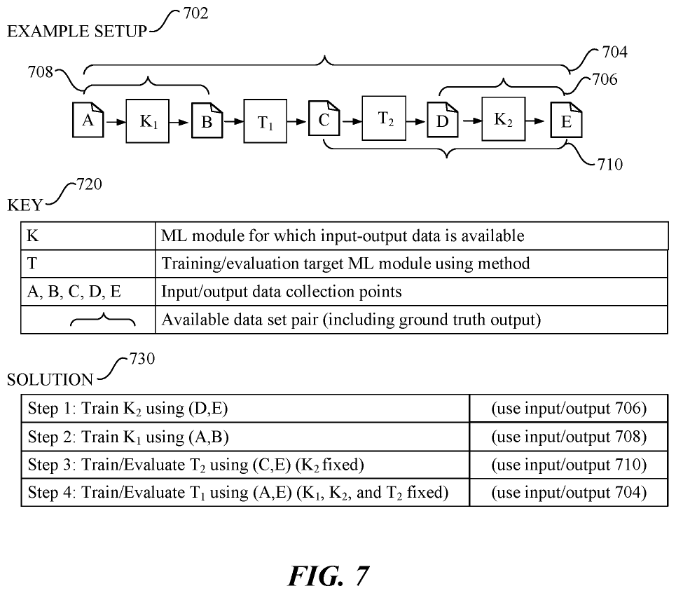

FIG. 7 shows an illustrative scenario for evaluating or training one or more machine learning (ML) modules when their corresponding truth data sets are unavailable or unreliable, in accordance with yet another embodiment of the invention. The example scenario 702 shows four concatenated ML modules K₁, T₁, T₂, and K₂, with intermediate data collection points A, B, C, D, and E. The concatenated ML modules comprise two target modules to be evaluated and/or trained (T₁ and T₂) and two modules having available ground truth input-output data sets (K₁ and K₂). The available ground truth data sets are indicated by braces (i.e., “{” curly brackets), as indicated in the figure key 720.

In the example scenario of FIG. 7, ground truth input-output data sets are available for K₁ 708 and K₂ 706, but also for the concatenations of modules “T₂ and K₂” 710 and “K₁, T₁, T₂, and K₂” 704, the latter representing global (or system) input-output.

Illustrative steps for training the two target ML modules T₁ and T₂ are shown in a solution listing at the bottom of FIG. 7. These steps 730 start with the training of individual ML modules for which ground truth input-output data is available, such as training K₁ in step 1 and training K₂ in step 2. These steps 730 then progress to training the target ML modules, starting with a target module located within a concatenation of ML modules having available ground truth input-output data sets (e.g., “T₂ and K₂” 710 and “K₁, T₁, T₂, and K₂” 704), but where all ML modules except the current target ML module are already trained or evaluated/selected. In FIG. 7, only the concatenation of “T₂ and K₂” 710 satisfies the listed requirements. Hence, in step 3 of the listed solution steps 730, T₂ is the first target ML module to be trained. Finally, in step 4 of the listed solution steps 730, T₁ is trained using the system input-output data set 704.

It is important to note that, following any training step in the solution steps 730 of FIG. 7, each trained or selected ML module is “fixed” ahead of the next step, where fixing a ML module denotes the fixing of its parameters. As described in the context of FIG. 5, in addition to training target ML modules, the current invention can be used to evaluate a set of pre-trained ML modules in view of selecting at least one target ML module. Hence, the solution steps of FIG. 7 730 apply for both training and evaluating/selecting target ML modules.

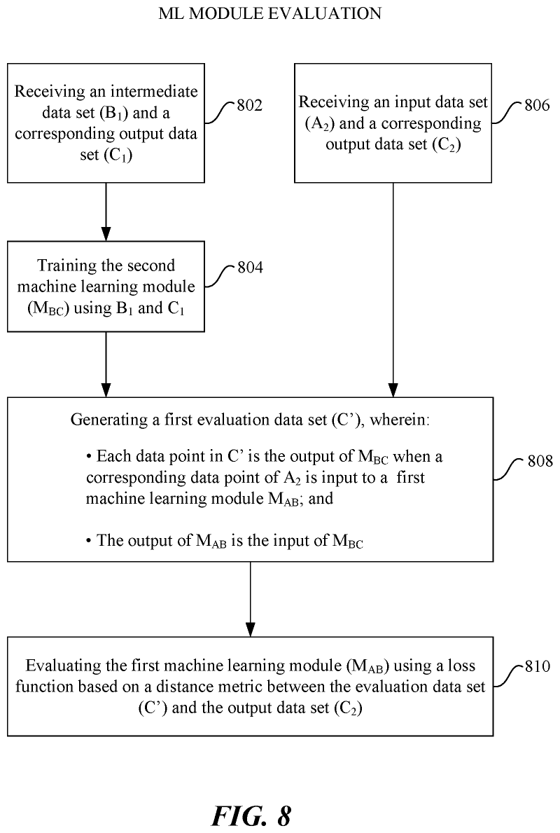

FIG. 8 shows an example flow diagram for a ML module evaluation process without corresponding truth data sets, in accordance with another embodiment of the invention. FIG. 8 shows a method for evaluating a first machine learning module (M_{AB}) having one input and one output, wherein M_{AB} is connected to a second machine learning module (M_{BC}) having one input and one output, such that the output of M_{AB} is the input of M_{BC}.

The evaluation method comprises receiving 802 an intermediate data set (B₁) and a corresponding output data set (C₁), wherein B₁ represents input for M_{BC}, and C₁ represents corresponding ground truth output for M_{BC}. The method then comprises training 804 module M_{BC} using B₁ and C₁. The evaluation method also comprises receiving 806 an input data set (A₂) and a corresponding output data set (C₂), wherein A₂ represents input for M_{AB}, and C₂ represents corresponding ground truth output for M_{BC}. The receiving of (B₁, C₁) 802 and (A₂, C₂) 806 may occur in any order.

The evaluation method then comprises generating 808 a first evaluation data set (C′), wherein each data point in C′ is the output of M_{BC} when a corresponding data point of A₂ is input to M_{AB}. Finally, the evaluation method comprises evaluating 810 the first machine learning module (M_{AB}) using a loss function based on a distance metric between the evaluation data set (C′) and the output data set (C₂). Loss function computation is further discussed below.

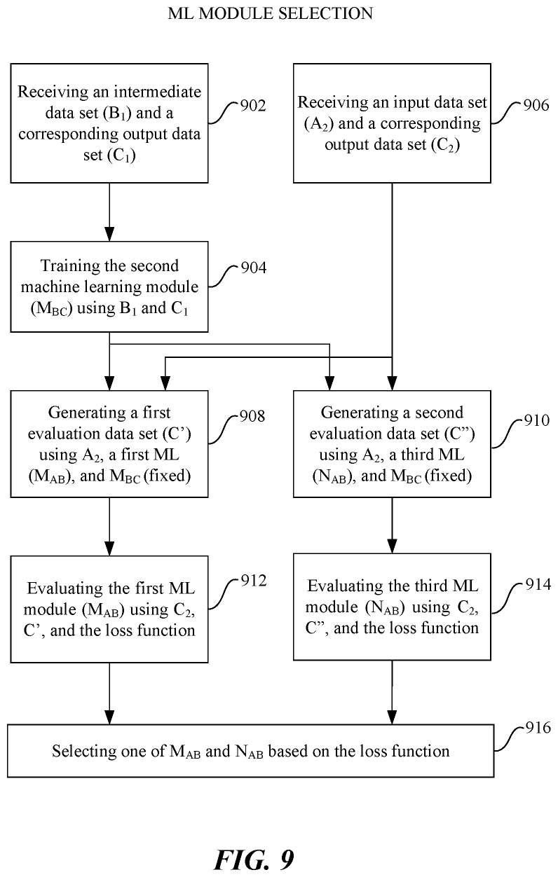

FIG. 9 shows an example flow diagram for a ML selection process without corresponding truth data sets, in accordance with another embodiment of the invention. FIG. 8 shows a method for evaluating a first machine learning module (M_{AB}) and a third machine learning module (N_{AB}) then selecting one of the two ML modules based on a loss function. The two ML modules are assumed to be pre-trained and each one of them can be substituted for the another. Both have one input and one output, wherein each of them can be connected to a second machine learning module (M_{BC}) having one input and one output, such that the output of M_{AB} (or, alternatively, of N_{AB}) is the input of M_{BC}.

As in the evaluation method of FIG. 8, the selection method of FIG. 9 comprises receiving 902 an intermediate data set (B₁) and a corresponding output data set (C₁), wherein B₁ represents input for M_{BC}, and C₁ represents corresponding ground truth output for M_{BC}. The selection method then comprises training 904 module M_{BC} using B₁ and C₁. The method also comprises receiving 906 an input data set (A₂) and a corresponding output data set (C₂), wherein the A₂ represents input for M_{AB}, and C₂ represents corresponding ground truth output for M_{BC}. The receiving of (B₁, C₁) 902 and (A₂, C₂) 906 may occur in any order.

The selection method then comprises generating 908 a first evaluation data set (C′), wherein each data point in C′ is the output of the previously trained M_{BC} when a corresponding data point of A₂ is input to M_{AB}, and M_{AB} is connected to M_{BC}. The selection method then comprises evaluating 912 the first machine learning module (M_{AB}) using a loss function based on a distance metric between the evaluation data set (C′) and the output data set (C₂).

The selection method also comprises generating 910 a second evaluation data set (C″), wherein each data point in C″ is the output of the previously trained M_{BC} when a corresponding data point of A₂ is input to N_{AB}, and N_{AB} is connected to M_{BC}. The selection method then comprises evaluating 914 the third machine learning module (N_{AB}) using a loss function based on a distance metric between the evaluation data set (C″) and the output data set (C₂).

Finally, the selection method comprises selecting 916 one of M_{AB} and N_{AB} based on the loss function.

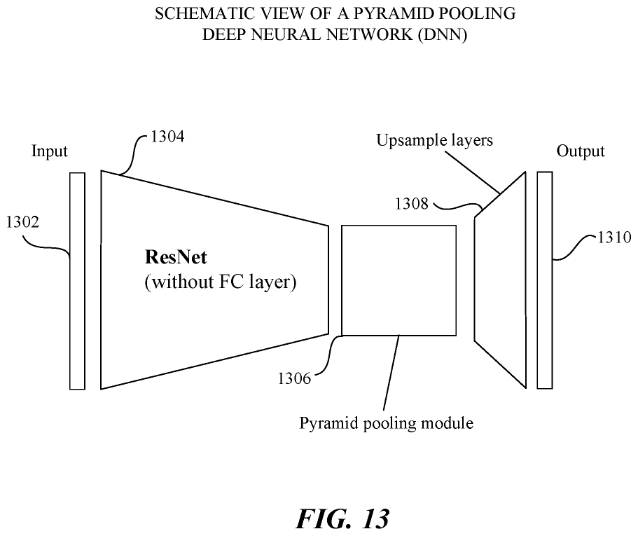

In various embodiments of the present invention, the first machine learning module (M_{AB}) 104, 214, 634, 644, 654, may be deep neural network (DNN) or a regressor. In particular, the first machine learning module (M_{AB}) may be a residual neural network (ResNet), or a DNN based on a ResNet, as discussed below in the context of FIG. 13. In other embodiments of the present invention, the second machine learning module (M_{BC}) 108, 218, 638, 648, 658, may be deep neural network (DNN) or a regressor.

Other machine learning methods are also within the scope of the annotation and measurement ML modules. For example, other ML algorithms including, but are not limited to, nearest neighbor, decision trees, support vector machines (SVM), Adaboost, Bayesian networks, fuzzy logic models, various neural networks including deep learning networks, evolutionary algorithms, and so forth, are within the scope of the present invention. In the context of the present disclosure, the above ML methods represent different ML types.

In various embodiments of the present invention, the first ML module (M_{AB}) 104, 214, 634, 644, 654 is a different type of machine learning module than the second ML module (M_{BC}) 108, 218, 638, 648, 658. ML types denote ML methods using distinct architectures and characteristic parameter sets. For example, decision trees, nearest neighbor algorithms, various neural networks (e.g., CNNs, ResNets), regressors, SVMs, fuzzy logic models, and evolutionary algorithms represent different ML types.

In various embodiments of the present invention, the first ML module (M_{AB}) 104, 214, 634, 644, 654 has a different type of output than the second ML module (M_{BC}) 108, 218, 638, 648, 658. In the example of FIG. 2 and the examples below, the output of the first ML module (M_{AB}) comprises keypoint annotations of one or more body parts under clothing, while the output of the second ML module (M_{BC}) comprises measurements of one or more body parts. Keypoints (i.e., 2D landmark indicators) and measurements (i.e., single real values or vectors of real values) represent distinct types of output. In addition to body-part keypoints and body-part measurements, other distinct types of outputs include 2D images, 3D images, 2D heatmaps, 3D heatmaps, 1D metrics (e.g., single real or Boolean values), and vectors or tensors comprising meaningful and useful metrics (e.g., temperatures, distances/sizes, weights, etc.). Intermediate ML variables without real-world significance, such as intermediate DNN tensors (e.g., feature maps) that are commonly generated through freezing one or more neural network layers during training, are hence excluded.

In addition to the arguments discussed above relative to the distinctness and meaningfulness of outputs, the methods disclosed herein are distinct from the practice of freezing during neural network training in other crucial ways. First, contrary to the one or more neural network layers that are frozen, the methods disclosed herein require reliable input-output ground truth data to be available for the ML module to be “fixed” (e.g., module M_{BC} is FIG. 6, 9, 10, 12 or K₂ in FIG. 7). Second, the methods disclosed herein require the explicit training of the ML module that is to be fixed using its specific input-output ground truth data sets. The present invention hence distinguishes itself from freezing by requiring the full training of any ML module that is to be “fixed”, using received reliable input-output ground truth data sets, in order to evaluate or train another connected or concatenated ML module, as shown in FIG. 7.

In some embodiments, in addition to the evaluation of a first ML module (M_{AB}) using the loss function described in FIGS. 6 and 8, the present invention comprises tuning the parameters of M_{AB} based on the loss function, where tuning comprises modifying the parameters of a ML module. For example, in a DNN, parameters may include weights, coefficients, number of layers, number of training iterations, etc. These and other aspects of the ML module architecture may be considered to be tuning parameters, as illustrated in the tuning example provided below.

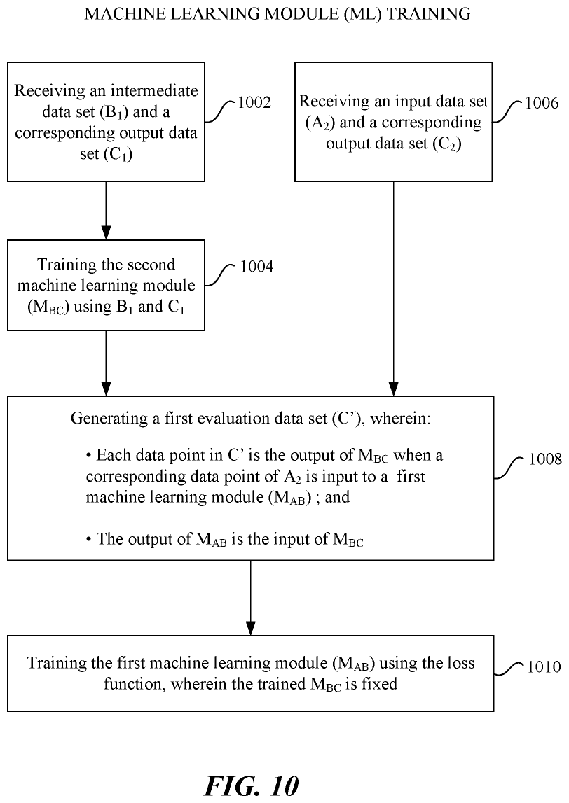

FIG. 10 shows an example flow diagram for a ML training process without corresponding truth data sets, in accordance with another embodiment of the invention. In FIG. 10, a first machine learning module (M_{AB}) having one input and one output is evaluated and trained, wherein M_{AB} is connected to a second machine learning module (M_{BC}) having one input and one output, such that the output of M_{AB} is the input of M_{BC}.

As discussed above in the context of FIG. 6, the training method carries the same initial steps as the evaluation method, comprising receiving 1002 an intermediate data set (B₁) and a corresponding output data set (C₁), wherein B₁ represents input for M_{BC}, and C₁ represents corresponding ground truth output for M_{BC}. The training method then comprises training 1004 module M_{BC} using B₁ and C₁. The training method also comprises receiving 1006 an input data set (A₂) and a corresponding output data set (C₂), wherein A₂ represents input for M_{AB}, and C₂ represents corresponding ground truth output for M_{BC}. The receiving of (B₁, C₁) 402 and (A₂, C₂) 1006 may occur in any order.

The training method then comprises generating 1008 a first evaluation data set (C′), wherein each data point in C′ is the output of M_{BC} when a corresponding data point of A₂ is input to M_{AB}. Finally, the training method comprises training 1010 the first machine learning module (M_{AB}) using a loss function based on a distance metric between the evaluation data set (C′) and the output data set (C₂), wherein the parameters of the trained M_{BC} are fixed.

As discussed above in the context of FIG. 6, training is an iterative feedback process where the generation of new batches of evaluation data (similar to C′) is repeated, leading to new values of the loss function that shape M_{AB} parameters, until a level of convergence between the latest evaluation batches and the ground truth data set (C₂) is achieved. Naturally, the parameters of the second ML module (M_{BC}) are kept constant throughout the training process. Training and parameter tuning are further discussed in the examples below.

### Annotator Evaluation

The methods described in the present disclosure can be used to evaluate any transformation T operating on an input to generate a useful output. One such transformation is manual annotation, a transformation converting images of body parts under clothing into keypoints of body parts under clothing, as depicted in FIG. 3. The manual annotator of FIG. 3 can thus be substituted with any transformation T for which ground truth output is unavailable, complex, costly, unreliable, or partial.

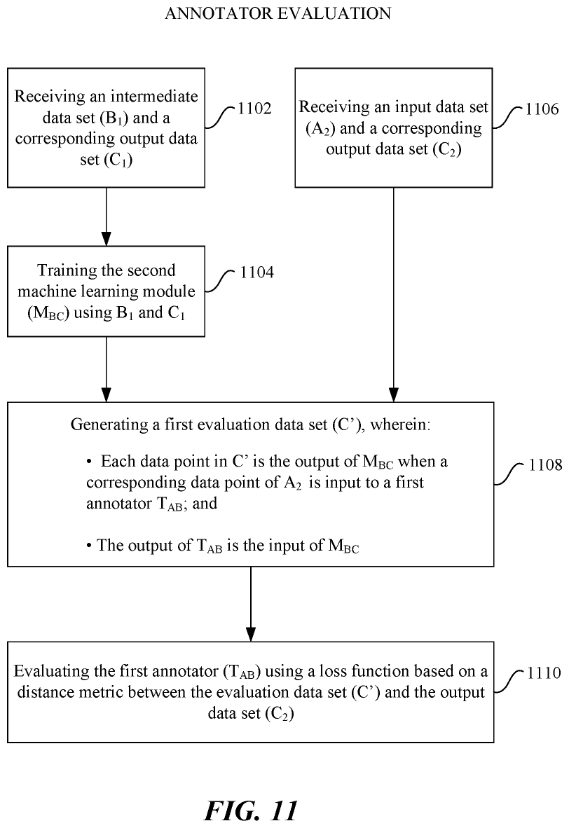

FIG. 11 shows an example flow diagram for evaluating an annotator without input-output data sets, in accordance with an embodiment of the invention. In FIG. 11, a first annotator (T_{AB}) generating keypoint annotations of one or more body parts under clothing from one or more photos of clothed individuals is evaluated, wherein the keypoint annotations are input to a machine learning module (M_{BC}) used to generate one or more body part measurements.

The evaluation method comprises receiving 1102 a keypoint data set (B₁) and a corresponding measurement data set (C₁), wherein B₁ represents input for the M_{BC}, and C₁ represents corresponding ground truth output for the M_{BC}. M_{BC} is then trained 1104 using B₁ and C₁, as is the case in the ML module evaluation method. The evaluation process also comprises receiving 1106 a photo data set (A₂) and a corresponding measurement data set (C₂), wherein A₂ comprises photos of clothed individuals, and C₂ comprises measurements of one or more body parts of the clothed individuals.

A first evaluation data set (C′) is then generated 1108, wherein each data point in C′ is a body part measurement generated by M_{BC} when a corresponding photo of A₂ is manually annotated by T_{AB}. Finally, the annotator evaluation method comprises evaluating 1110 the first annotator (T_{AB}) using a loss function based on a distance metric between the evaluation data set (C′) and the measurement data set (C₂).

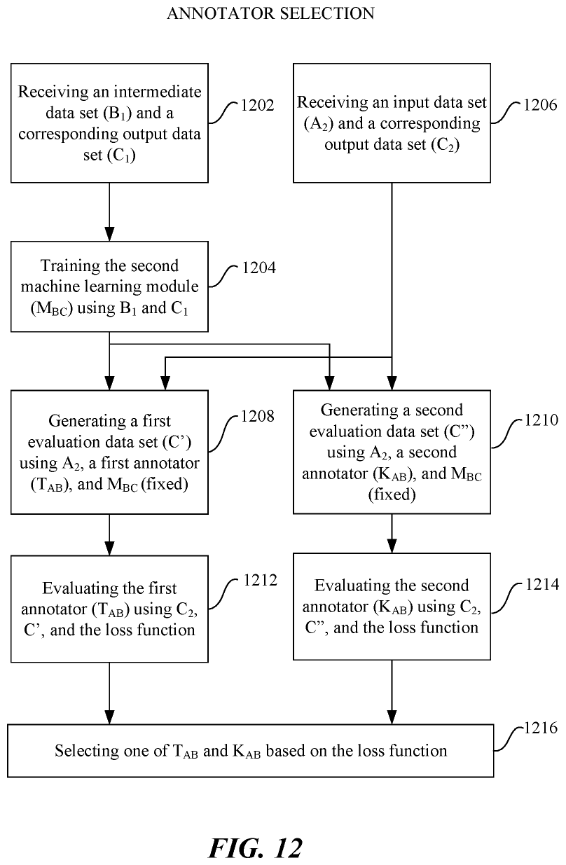

FIG. 12 shows an example flow diagram for selecting an annotator without input-output data sets, in accordance with another embodiment of the invention. In FIG. 11, a first annotator (T_{AB}) and a second annotator (K_{AB}) are evaluated and one of them is selected based on a loss function. Both annotators generate keypoint annotations of one or more body parts under clothing from one or more photos of clothed individuals, wherein the keypoint annotations are input to a machine learning module (M_{BC}) used to generate one or more body part measurements.

The selection method comprises receiving 1202 a keypoint data set (B₁) and a corresponding measurement data set (C₁), wherein B₁ represents input for the M_{BC}, and C₁ represents corresponding ground truth output for the M_{BC}. M_{BC} is then trained 1204 using B₁ and C₁, as is the case in the ML module evaluation method. The selection process also comprises receiving 1206 a photo data set (A₂) and a corresponding measurement data set (C₂), wherein A₂ comprises photos of clothed individuals, and C₂ comprises measurements of one or more body parts of the clothed individuals.

A first evaluation data set (C′) is then generated 1208, wherein each data point in C′ is a body part measurement generated by M_{BC} when a corresponding photo of A₂ is manually annotated by T_{AB}. The first annotator (T_{AB}) is then evaluated 1212 using a loss function based on a distance metric between the evaluation data set (C′) and the measurement data set (C₂).

A second evaluation data set (C″) is also generated 1210, wherein each data point in C″ is a body part measurement generated by M_{BC} when a corresponding photo of A₂ is manually annotated by K_{AB}. The second annotator (K_{AB}) is then evaluated 1214 using a loss function based on a distance metric between the evaluation data set (C″) and the measurement data set (C₂).

Finally, the annotator selection method comprises selecting 1216 one of the T_{AB} and the K_{AB} based on the loss function.

In some embodiments, the present invention is therefore a computer-implemented method for evaluating a first annotator (T_{AB}) generating keypoint annotations of one or more body parts under clothing from one or more photos of clothed individuals, wherein the keypoint annotations are input to a machine learning module (M_{BC}) used to generate one or more body part measurements, the computer-implemented method executable by a hardware processor, the method comprising: receiving a keypoint data set (B₁) and a corresponding measurement data set (C₁), wherein the B₁ represents a data set input for the M_{BC}, and the C₁ represents a corresponding ground truth output data set for the M_{BC}; training the M_{BC} using the B₁ and the C₁; receiving a photo data set (A₂) and a corresponding measurement data set (C₂), wherein the A₂ comprises photos of clothed individuals, and the C₂ comprises measurements of one or more body parts of the clothed individuals; generating a first evaluation data set (C′), wherein each data point in C′ is a body part measurement generated by the M_{BC} when a corresponding photo of A₂ is annotated by the T_{AB}; and evaluating the first annotator (T_{AB}) using a loss function based on a distance metric between the evaluation data set (C′) and the measurement data set (C₂).

In one embodiment, the method further comprises substituting the T_{AB} with a second annotator (K_{AB}), wherein the keypoint annotations generated by the K_{AB} are input to the M_{BC} to generate one or more body part measurements; generating a second evaluation data set (C″), wherein: each data point in C″ is a body part measurement generated by the M_{BC} when a corresponding photo of A₂ is annotated by the K_{AB}; evaluating the performance of the K_{AB} using the loss function based on the distance metric between the C″ and the C₂; and selecting one of the T_{AB} and the K_{AB} based on the loss function.

### ML Model Tuning and Parameter Selection

FIG. 13 shows an illustrative diagram for a ML algorithm (used for generating keypoint annotations) for which parameters can be modified or tuned without corresponding ground truth data sets, in accordance with yet another embodiment of the invention. FIG. 13 shows an illustrative diagram for a ML algorithm used for generating keypoint annotations of one or more body parts under clothing from photos of clothed individuals, in accordance with an embodiment of the invention.

FIG. 13 is presented as an example of ML model tuning and parameter selection, in accordance with an embodiment of the invention. The base model to be tuned uses pyramid pooling, a down-sampling technique that allows DNN output to be independent from input image size, and robust to feature deformations and variations in feature location. The DNN used in the example of FIG. 13 is based on the Pyramid Scene Parsing Network (PSPNet), a commonly used image segmentation neural network that is particularly capable of taking into account the global context of an input image to make local feature predictions. In one embodiment, the PSPNet algorithm is implemented as described in Hengshuang Zhao, et al., “Pyramid Scene Parsing Network,” CVPR 2017, Nov. 9, 2017, available at arXiv:1612.01105, which is hereby incorporated by reference in its entirety herein as if fully set forth herein.

The example PSPNet of FIG. 13 uses a residual network (ResNet) backbone 1304 (e.g. ResNet-34), enabling deeper network architectures. The ResNet backbone is followed by the pyramid pooling module 1306 and upsample layers 1308. In one embodiment, the ResNet algorithm is implemented as described in Kaiming He, et al., “Deep Residual Learning for Image Recognition,” CVPR 2016, Dec. 12, 2016, available at arXiv:1512.03385, which is hereby incorporated by reference in its entirety herein as if fully set forth herein.

ResNet backbone architectures may also include ResNeXt. In one embodiment, the ResNeXt algorithm is implemented as described in Saining Xie, et al., “Aggregated Residual Transformations for Deep Neural Networks,” CVPR 2017, Nov. 9, 2017, available at arXiv:1611.05431, which is hereby incorporated by reference in its entirety herein as if fully set forth herein.

In the example of FIG. 13, the input 1302 format for the ResNet is an RGB image having eight-bit integer arrays (int8) stored in a three-dimensional array with shape (height, width, color). The output 1310 is a landmark heatmap comprising real values (float) stored in a three-dimensional array with shape (height, width, landmark). The tuning parameters that can be modified based on a loss function (810, 912, 914) comprise the ResNet backbone layer architecture (ResNet-34, -50, -101, ResNeXt, etc.), as well as the number of training iterations (i.e., number of epochs).

PSPNet, ResNet, and ResNeXt are only illustrative deep learning network algorithms that are within the scope of the present invention, and the present invention is not limited to the use of PSPNet or ResNet. Other ML algorithms are also within the scope of the present invention. For example, in one embodiment of the present invention, a convolutional neural network (CNN) is utilized as a ML module to extract and to annotate body parts.

### Training a DNN Through a Regressor

FIGS. 2 and 6 show an illustrative setup where a trained regressor 218 can be used to train a DNN 214, in accordance with an embodiment of the invention. The approach described below uses regressor-side information to achieve DNN training through a loss function.

The final objective is to train the annotation DNN, denoted G, based on a loss function expressed by the following function:

G*=arg_{G} min [symbol] {∥z_{R}−R_{GT}(G(x_{G}))∥²}

where:
G is the training and evaluation target DNN (104, 214, 634, 644, 654). More generally, G is any ML module and corresponds to M_{AB} in FIGS. 1, 6, 8, and 10. G* is the DNN with parameters that minimize the loss function.
[symbol] denotes the expected value.
x_{G} represents an input image data batch. More generally, x_{G} is a subset of input data set A₂ 642, 652, 1006.
G(x_{G}) is the resulting intermediate data batch. In this example, G(x_{G}) is a batch of keypoint annotations. More generally, G(x_{G}) is a subset of intermediate data set B′ 656.
z_{R} is a true body measurement data batch. More generally, z_{R} corresponds to a subset of output data set C₁ 640, 1002.
R is the second ML module. In this example, R is a regressor converting keypoint annotations to measurements.
R_{GT} is the trained version or R, where the “GT” subscript denotes ground truth. R_{GT} is therefore the fixed-parameter (i.e., trained and fixed) regressor that previously learned mapping keypoints to measurements from a keypoint data batch to true body measurement data batch z_{R}. (i.e., a subset of output data set C₁ 640, 1002). More generally, R_{GT} is the trained and fixed version of the second ML module M_{BC} (108, 218, 638, 648, 658).
R_{GT}(G(x_{G})) is the output of R_{GT} when x_{G} is input to G. More generally, R_{GT}(G(x_{G})) is an evaluation output data batch (i.e., a subset of evaluation data set C′ 660, 1008).
L_{R}=∥z_{R}−R_{GT}(G(x_{G})∥² is the loss term in the loss function. In this embodiment, it represents the mean absolute error (MAE) between the evaluation data and ground truth data batches. Note that any batch distance measure (e.g., mean squared error (MSE), mean squared deviation (MSD), mean squared prediction error (MSPE)) can be used.

In another embodiment of the present invention, a partial or unreliable form of the intermediate ground truth data set may be available. For example, such data may be generated through simulation or any other external evaluation method. Referring to FIG. 1, corresponding input-output ground truth data sets may be available for M_{AB}, albeit unreliable or incomplete. In that case, a new loss function term L_{G}=∥y_{G}−G(x_{G})∥² may be added to the loss function as shown in the following expression:

G*=arg_{G} min [symbol] {λ∥y_{G}−G(x_{G})∥²+∥z_{R}−R_{GT}(G(x_{G})∥²}

where:
y_{G} is an unreliable or incomplete keypoint annotation (i.e., pseudo-label landmark heatmap) ground truth data batch corresponding to x_{G}. More generally, y_{G} corresponds to a subset of an unreliable or incomplete intermediate ground truth output data set B for the first ML module M_{AB}.
L_{G}=∥y_{G}−G(x_{G})∥² and L_{R}=∥z_{R}−R_{GT}(G(x_{G})∥² represent the MAE between the input data and ground truth output data batches for G and R, respectively. Note that any batch distance measure (e.g., MSE, MSD, or MSPE) can be used.
The weight represents a hyper parameter that controls the influence of the DNN data (i.e., the term related to the first ML module). When is set to zero, the loss function reduces to the form discussed above. may also serve to normalize loss terms having different units or emanating from different types of output. In this case, L_{G} is a keypoint/landmark distance whereas L_{R} is a measurement distance.

Using the loss functions described above, the DNN hence learns the mapping from the image set x_{G} and a trained regressor loss (L_{R}), with an optional weighted adjustment from DNN loss term (L_{G}) based on a pseudo-label (landmark heatmap) y_{G}.

In one embodiment, a training procedure associated with the loss functions described above is the following:
1. Initialize weights of G
2. Until convergence condition is satisfied do
   2.1. Until all batches processed do
      2.1.1. Calculate forward path of G
      2.1.2. Evaluate components of the loss function (e.g., L_{G} and L_{R})
      2.1.3. Calculate backward path of G based on the loss function
      2.1.4. Update weights of G

It is important to note that the steps listed under (2.1) in the algorithm above operate on batches of data. Hence, corresponding data sets (e.g., input images and corresponding ground truth measurement outputs) are divided into batches for steps (2.1.1) through (2.1.4). Batches and data sets can be reused in training procedures.

In addition, the convergence condition typically reflects the training goals. For example, reaching a value of the loss function that is below a given loss threshold is a typical convergence condition that implies a satisfactory distance between the model output and ground truth output (e.g., predicted vs. real measurements). Apart from the loss function, convergence conditions may be a function of other additional factors such as the number of loops (i.e., epochs) or batches traversed.

### Exemplary System Architecture

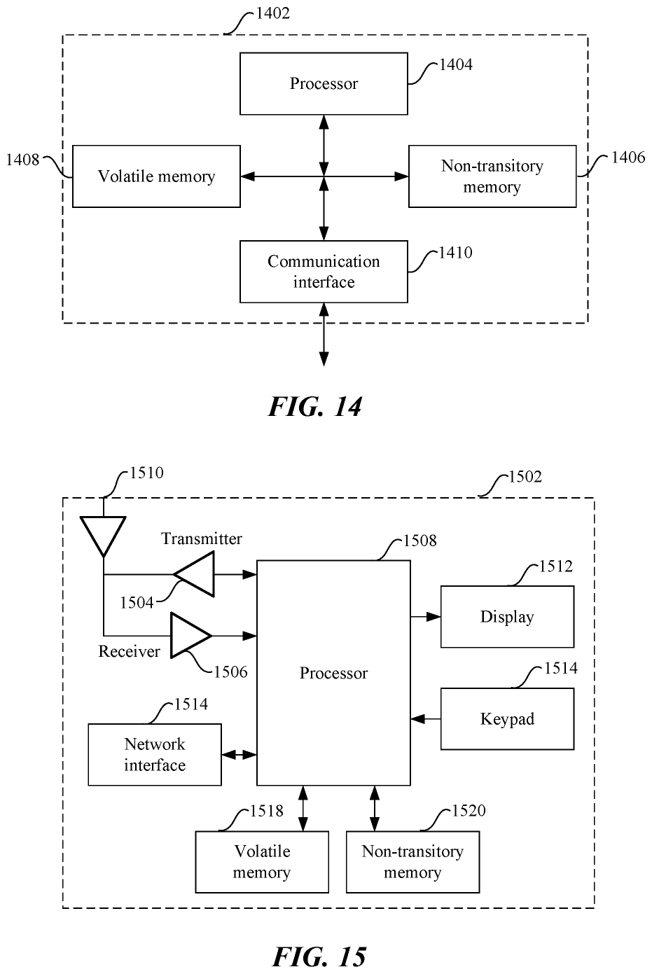

An exemplary embodiment of the present disclosure may include one or more servers (management computing entities), one or more networks, and one or more clients (user computing entities). Each of these components, entities, devices, and systems (similar terms used herein interchangeably) may be in direct or indirect communication with, for example, one another over the same or different wired or wireless networks. Additionally, while FIGS. 14 and 15 illustrate the various system entities as separate, standalone entities, the various embodiments are not limited to this particular architecture.

### Exemplary Management Computing Entity

FIG. 14 provides a schematic of a server (management computing entity) 1402 according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably).

As indicated, in one embodiment, the management computing entity 1402 may also include one or more communications interfaces 1410 for communicating with various computing entities, such as by communicating data, content, and/or information (similar terms used herein interchangeably) that can be transmitted, received, operated on, processed, displayed, stored, and/or the like.

As shown in FIG. 14, in one embodiment, the management computing entity 1402 may include or be in communication with one or more processors (i.e., processing elements) 1404 (also referred to as processors and/or processing circuitry—similar terms used herein interchangeably) that communicate with other elements within the management computing entity 1402 via a bus, for example. As will be understood, the processor 1404 may be embodied in a number of different ways. For example, the processor 1404 may be embodied as one or more complex programmable logic devices (CPLDs), microprocessors, multi-core processors, coprocessing entities, application-specific instruction-set processors (ASIPs), microcontrollers, and/or controllers. Further, the processor 1404 may be embodied as one or more other processing devices or circuitry. The term circuitry may refer to an entire hardware embodiment or a combination of hardware and computer program products. Thus, the processor 1404 may be embodied as integrated circuits, application-specific integrated circuits (ASICs), field-programmable gate arrays (FPGAs), programmable logic arrays (PLAs), hardware accelerators, other circuitry, and/or the like. As will therefore be understood, the processor 1404 may be configured for a particular use or configured to execute instructions stored in volatile or non-volatile (or non-transitory) media or otherwise accessible to the processor 1404. As such, whether configured by hardware or computer program products, or by a combination thereof, the processor 1404 may be capable of performing steps or operations according to embodiments of the present disclosure when configured accordingly.

In one embodiment, the management computing entity 1402 may further include or be in communication with non-transitory memory (also referred to as non-volatile media, non-volatile storage, non-transitory storage, memory, memory storage, and/or memory circuitry—similar terms used herein interchangeably). In one embodiment, the non-transitory memory or storage may include one or more non-transitory memory or storage media 1406, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile (or non-transitory) storage or memory media may store databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity 1402 may further include or be in communication with volatile media (also referred to as volatile storage, memory, memory storage, memory and/or circuitry—similar terms used herein interchangeably). In one embodiment, the volatile storage or memory may also include one or more volatile storage or memory media 1408, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor 1404. Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity 1402 with the assistance of the processor 1404 and operating system.

As indicated, in one embodiment, the management computing entity 1402 may also include one or more communications interfaces 1410 for communicating with various computing entities, such as by communicating data, content, and/or information (similar terms used herein interchangeably) that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 1402 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity 1402 may include or be in communication with one or more input elements, such as a keyboard input, a mouse input, a touch screen/display input, motion input, movement input, audio input, pointing device input, joystick input, keypad input, and/or the like. The management computing entity 1402 may also include or be in communication with one or more output elements (not shown), such as audio output, video output, screen/display output, motion output, movement output, and/or the like.

As will be appreciated, one or more of the components of the management computing entity 1402 may be located remotely from other management computing entity 1402 components, such as in a distributed system. Furthermore, one or more of the components may be combined and additional components performing functions described herein may be included in the management computing entity 1402. Thus, the management computing entity 1402 can be adapted to accommodate a variety of needs and circumstances. As will be recognized, these architectures and descriptions are provided for exemplary purposes only and are not limiting to the various embodiments.

### Exemplary User Computing Entity

A user may be an individual, a company, an organization, an entity, a department within an organization, a representative of an organization and/or person, and/or the like. FIG. 15 provides an illustrative schematic representative of a client (user computing entity) 1502 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles, watches, glasses, key fobs, radio frequency identification (RFID) tags, earpieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 1502 can be operated by various parties. As shown in FIG. 15, the user computing entity 1502 can include an antenna 1510, a transmitter 1504 (e.g., radio), a receiver 1506 (e.g., radio), and a processor (i.e., processing element) 1508 (e.g., CPLDs, microprocessors, multi-core processors, coprocessing entities, ASIPs, microcontrollers, and/or controllers) that provides signals to and receives signals from the transmitter 1504 and receiver 1506, respectively.

The signals provided to and received from the transmitter 1504 and the receiver 1506, respectively, may include signaling information in accordance with air interface standards of applicable wireless systems. In this regard, the user computing entity 1502 may be capable of operating with one or more air interface standards, communication protocols, modulation types, and access types. More particularly, the user computing entity 1502 may operate in accordance with any of a number of wireless communication standards and protocols, such as those described above with regard to the management computing entity 1502. In a particular embodiment, the user computing entity 1502 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 1502 may operate in accordance with multiple wired communication standards and protocols, such as those described above with regard to the management computing entity 1402 via a network interface 1514.

Via these communication standards and protocols, the user computing entity 1502 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 1502 can also download changes, add-ons, and updates, for instance, to its firmware, software (e.g., including executable instructions, applications, program modules), and operating system.

According to one embodiment, the user computing entity 1502 may include location determining aspects, devices, modules, functionalities, and/or similar words used herein interchangeably. For example, the user computing entity 1502 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 1502 position in connection with a variety of other systems, including cellular towers, Wi-Fi access points, and/or the like. Similarly, the user computing entity 1502 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 1502 may also comprise a user interface (that can include a display 1512 coupled to a processor 1508 and/or a user input interface coupled to a processor 1508. For example, the user interface may be a user application, browser, user interface, and/or similar words used herein interchangeably executing on and/or accessible via the user computing entity 1502 to interact with and/or cause display of information from the management computing entity 1402, as described herein. The user input interface can comprise any of a number of devices or interfaces allowing the user computing entity 1502 to receive data, such as a keypad 1514 (hard or soft), a touch display, voice/speech or motion interfaces, or other input device. In embodiments including a keypad 1514, the keypad 1514 can include (or cause display of) the conventional numeric (0-9) and related keys (#, *), and other keys used for operating the user computing entity 1502 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 1502 can also include volatile storage or memory 1518 and/or non-transitory storage or memory 1520, which can be embedded and/or may be removable. For example, the non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory can store databases, database instances, database management systems, data, applications, programs, program modules, scripts, source code, object code, byte code, compiled code, interpreted code, machine code, executable instructions, and/or the like to implement the functions of the user computing entity 1502. As indicated, this may include a user application that is resident on the entity or accessible through a browser or other user interface for communicating with the management computing entity 1402 and/or various other computing entities.

In another embodiment, the user computing entity 1502 may include one or more components or functionality that are the same or similar to those of the management computing entity 1402, as described in greater detail above. As will be recognized, these architectures and descriptions are provided for exemplary purposes only and are not limiting to the various embodiments.

### Exemplary Client Server Environment

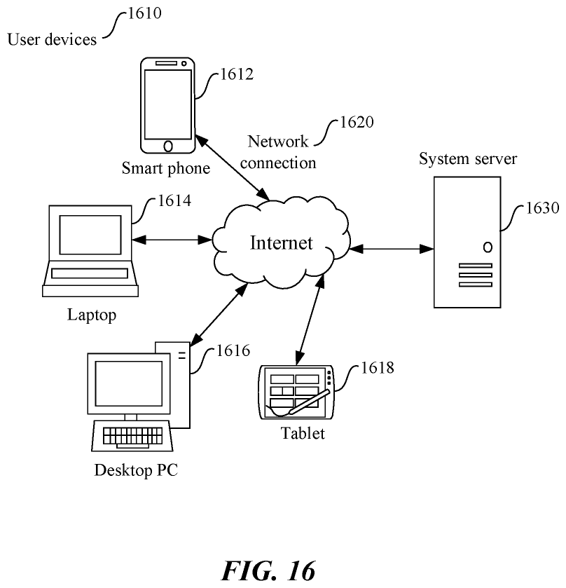

The present invention may be implemented in a client server environment. FIG. 16 shows an illustrative system architecture for implementing one embodiment of the present invention in a client server environment. User devices (i.e., image-capturing device) 1610 on the client side may include smart phones 1612, laptops 1614, desktop PCs 1616, tablets 1618, or other devices. Such user devices 1610 access the service of the system server 1630 through some network connection 1620, such as the Internet.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service) and increases user satisfaction and ease of use. Various business models, revenue models, and delivery mechanisms for the present invention are envisioned, and are all to be considered within the scope of the present invention.

### Additional Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto optical disks, or optical disks. However, a computer need not have such devices. Devices suitable for storing computer program instructions and information/data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back end component, e.g., as an information/data server, or that includes a middleware component, e.g., an application server, or that includes a front end component, e.g., a client computer having a graphical user interface or a web browser through which a user can interact with an implementation of the subject matter described herein, or any combination of one or more such back end, middleware, or front end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module or sequence of instructions referred to as “computer program(s)” or “computer code(s).” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### CONCLUSIONS

One of ordinary skill in the art knows that the use cases, structures, schematics, and flow diagrams may be performed in other orders or combinations, but the inventive concept of the present invention remains without departing from the broader scope of the invention. Every embodiment may be unique, and methods/steps may be either shortened or lengthened, overlapped with the other activities, postponed, delayed, and continued after a time gap, such that every user is accommodated to practice the methods of the present invention.

Although the present invention has been described with reference to specific exemplary embodiments, it will be evident that the various modification and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention.

1. A computer-implemented method for evaluating a first machine learning module having a first input and a first output, wherein the first machine learning module is connected to a second machine learning module having a second input and a second output, and wherein the first output of the first machine learning module is the second input of the second machine learning module, the computer-implemented method executable by a hardware processor, the method comprising:
receiving an intermediate data set and a corresponding output data set,
wherein the intermediate data set represents a data set for the second input of the second machine learning module, and
wherein the output data set represents a corresponding ground truth data set for the second output of the second machine learning module;
training the second machine learning module using the intermediate data set and the output data set;
receiving a system input data set and a corresponding system output data set,
wherein the system input data set represents a data set for the first input of the first machine learning module, and
wherein the system output data set represents a corresponding ground truth data set for the second output of the second machine learning module;
generating a first evaluation data set to evaluate the first machine learning module while the first machine learning module is connected to the trained second machine learning module,
wherein each data point in the first evaluation data set is generated by the trained second machine learning module in response to a corresponding data point of the system input data set that is input to the first machine learning module, and
wherein the trained second machine learning module is fixed; and
evaluating the first machine learning module without using a ground truth data set for the first output of the first machine learning module, using a loss function based on a first distance metric between the first evaluation data set and the system output data set,
wherein the system input data set comprises photos of clothed individuals, the intermediate data set comprises keypoint annotations of one or more body parts under clothing, and the output data sets (output data set and system output data set) comprise measurements of the one or more body parts.

2. The computer-implemented method of claim 1, further comprising:
substituting the first machine learning module with a third machine learning module having a third input and a third output, such that the third output of the third machine learning module is the second input of the second machine learning module;
generating a second evaluation data set,
wherein each data point in the second evaluation data set is generated by the second machine learning module when a corresponding data point of system input data set is input to the third machine learning module;
evaluating the third machine learning module using the loss function based on a second distance metric between the second evaluation data set and the system output data set; and
selecting one of the first machine learning module and the third machine learning module based on the loss function.

3. The computer-implemented method of claim 1, further comprising:
tuning the parameters of the first machine learning module based on the loss function.

4. The computer-implemented method of claim 1, wherein the first machine learning module is a different type of machine learning module than the second machine learning module.

5. The computer-implemented method of claim 1, wherein the first machine learning module has a different type of output than the second machine learning module.

6. The computer-implemented method of claim 1, further comprising:
training the first machine learning module while the first machine learning module is connected to the trained second machine learning module, without using a ground truth data set for the first output of the first machine learning module, using the loss function, the system input data set, and the system output data set, wherein the trained second machine learning module is fixed.

7. (canceled)

8. The computer-implemented method of claim 1, wherein the first machine learning module is selected from the group consisting of a deep neural network (DNN) and a regressor.

9. The computer-implemented method of claim 8, wherein the first machine learning module is a residual neural network (ResNet).

10. The computer-implemented method of claim 1, wherein the second machine learning module is selected from the group consisting of a deep neural network (DNN) and a regressor.

11. The computer-implemented method of claim 1, wherein the first distance metric is a batch distance measure selected from the group consisting of a mean absolute error (MAE), a mean squared error (MSE), a mean squared deviation (MSD), and a mean squared prediction error (MSPE).

12. The computer-implemented method of claim 1, further comprising:
receiving an intermediate output data set corresponding to the system input data set, wherein the intermediate output data set represents a ground truth data set for the first output of the first machine learning module; and
generating an intermediate evaluation data set, wherein each data point in the intermediate evaluation data set is generated by the first machine learning module when a corresponding data point of the system input data set is input to the first machine learning module,
wherein the loss function is based on the first distance metric between the first evaluation data set and the system output data set and a third distance metric between the intermediate evaluation data set and the intermediate output data set.

13. A non-transitory storage medium storing program code for evaluating a first machine learning module having a first input and a first output, wherein the first machine learning module is connected to a second machine learning module having a second input and a second output, and wherein the first output of the first machine learning module is the second input of the second machine learning module, the program code executable by a hardware processor, the program code when executed by the processor, causing the processor to:
receive an intermediate data set and a corresponding output data set,
wherein the intermediate data set represents a data set for the second input of the second machine learning module, and
wherein the output data set represents a corresponding ground truth data set for the second output of the second machine learning module;
train the second machine learning module using the intermediate data set and the output data set;
receive a system input data set and a corresponding system output data set,
wherein the system input data set represents a data set for the first input of the first machine learning module, and
wherein the system output data set represents a corresponding ground truth data set for the second output of the second machine learning module;
generate a first evaluation data set to evaluate the first machine learning module while the first machine learning module is connected to the trained second machine learning module,
wherein each data point in the first evaluation data set is generated by the trained second machine learning module in response to a corresponding data point of the system input data set that is input to the first machine learning module, and
wherein the trained second machine learning module is fixed; and
evaluate the first machine learning module without using a ground truth data set for the first output of the first machine learning module, using a loss function based on a first distance metric between the first evaluation data set and the system output data set,
wherein the system input data set comprises photos of clothed individuals, the intermediate data set comprises keypoint annotations of one or more body parts under clothing, and the output data sets (output data set and system output data set) comprise measurements of the one or more body parts.

14. The non-transitory storage medium of claim 13, further comprising program code to:
substitute the first machine learning module with a third machine learning module having a third input and a third output, such that the third output of the third machine learning module is the second input of the second machine learning module;
generate a second evaluation data set,
wherein each data point in the second evaluation data set is generated by the second machine learning module when a corresponding data point of system input data set is input to the third machine learning module;
evaluate the third machine learning module using the loss function based on a second distance metric between the second evaluation data set and the system output data set; and
select one of the first machine learning module and the third machine learning module based on the loss function.

15. The non-transitory storage medium of claim 13, further comprising program code to:
tune the parameters of the first machine learning module based on the loss function.

16. The non-transitory storage medium of claim 13, wherein the first machine learning module is a different type of machine learning module than the second machine learning module.

17. The non-transitory storage medium of claim 13, wherein the first machine learning module has a different type of output than the second machine learning module.

18. The non-transitory storage medium of claim 13, further comprising program code to:
train the first machine learning module while the first machine learning module is connected to the trained second machine learning module, without using a ground truth data set for the first output of the first machine learning module, using the loss function, the system input data set, and the system output data set, wherein the trained second machine learning module is fixed.

19. (canceled)

20. The non-transitory storage medium of claim 13, wherein the first machine learning module is selected from the group consisting of a deep neural network (DNN) and a regressor.
